(19) United States
(12) Patent Application Publication
(10) Pub. No.: US 2006/0157095 A1
(43) Pub. Date: Jul. 20, 2006

(54) Systems and methods for spinning semiconductor wafers

(76) Inventor: Xuyen Ngoc Pham, Fremont, CA (US)

Correspondence Address: TRAN & ASSOCIATES, 6768 MEADOW VISTA CT., SAN JOSE, CA, 95135, US

(21) Appl. No.: 11/038,509

(22) Filed: Jan. 19, 2005

(51) Int. Cl. B08B 3/00

(52) U.S. Cl. 134/149; 134/155; 134/157; 134/94.1; 134/99.1

(57) ABSTRACT

Systems and methods are disclosed to process first and second sides of a wafer. The system includes a platform adapted to receive and rotate said wafer; and first and second heads coupled to the platform to access said first and second sides of said wafer.

### BACKGROUND

This invention relates to systems and methods for spinning semiconductor wafers.

In semiconductor fabrication, various layers of insulating, conducting and semi-conducting materials are deposited to produce a multilayer semiconductor device. Using various fabrication techniques such as coating, oxidation, implantation, deposition, epitomical growth of silicon, lithography, etching, and planarization, the layers are patterned to form elements such as transistors, capacitors, and resistors. These elements are then interconnected to achieve a desired electrical function in an integrated circuit (IC) device.

In many operations, residual unwanted materials such as post-etch, post-strip, chemicals and slurry particles accumulate on the surface of a wafer. If left on the surface of the wafer for subsequent fabrication operations, these unwanted residual materials and particles may cause, among other things, defects such as scratches on the wafer surface and inappropriate interactions between metallization features. In some cases, such defects may cause devices on the wafer to become inoperable.

To illustrate, fabrication operations such as plasma etching, stripping and chemical mechanical polishing (CMP) may leave unwanted residuals on the surface of the wafer. These unwanted residuals may be removed using water washing, chemical washing, Megasonic washing, or brush cleaning with deionized (DI) water, or a separate post-CMP cleaning. The post-CMP step is typically achieved by mechanical brush cleaning, using a polyvinyl alcohol (PVA) brush or sponge and DI water, or potassium or ammonium hydroxide as the cleaning agent. Other surface preparation processes can include chemical processes using various liquid chemicals.

FIG. 1 shows an exemplary prior art of typical spinning apparatus. A wafer 10 is positioned above a wafer chuck 12, both of which are contained in a shroud 14. The chuck 12 is connected to one end of a spindle shaft 19, while the other end of the spindle shaft 19 is connected to a pulley 20. The shaft 19 is centered in a spindle housing 18 using a plurality of spindle bearings 16. The pulley 20 is driven by a belt 22, which in turn is connected to a motor pulley 24. The motor pulley 24 is connected to a motor 26 which, when activated, rotates the pulley 20 to rotate the shaft 19 and the chuck 12 to spin the wafer 10 resting above the chuck 12.

### SUMMARY

Systems and methods are disclosed to process first and second sides of a wafer (such as the front and back of the wafer, for example). The system includes a platform adapted to receive and rotate said wafer; and first and second heads coupled to the platform to access said first and second sides of said wafer.

One or more of the following advantages may be achieved. The system allows easy access to both sides of the wafer. The system is easy to maintain. The design uses few components, yet robust in functionality. The design is also inexpensive to produce and maintain. Moreover, the arm provides a linear motion or a radial arm motion. A variety of heads/arms can be used for a variety of applications. In cleaning and drying applications, the system efficiently cleans and dries the wafer after fabrication operations that leave unwanted residue on one or both surfaces of the wafer. The improved wafer cleaning minimizes the undue costs of discarding wafers having inoperable devices. The bearings and moveable components are protected against moisture and chemicals. As a result, the mechanical components of the system are placed at a substantially lower risk of degradation.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 shows an exemplary prior art spin of typical spinning apparatus.

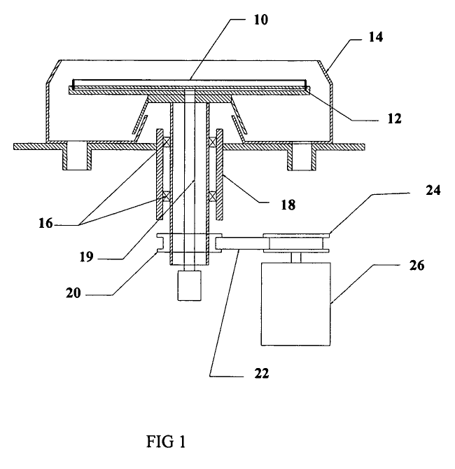

FIG. 2 illustrates an exemplary first embodiment of a spin apparatus that can access both sides of a wafer.

FIG. 3 illustrates an exemplary second embodiment of a spin apparatus with an adapter for different sized wafers.

FIG. 4 illustrates an exemplary third embodiment of a spin apparatus with an off-set mount to access both sides of a wafer.

FIG. 5 illustrates an exemplary embodiment of a modular fabrication platform having one cleaning/drying module.

FIG. 6 illustrates an exemplary embodiment of a modular fabrication platform having two cleaning/drying modules.

FIG. 7 illustrates an exemplary embodiment of a modular fabrication platform having three cleaning/drying modules.

FIG. 8 illustrates an exemplary embodiment of a modular fabrication platform having four cleaning/drying cells.

FIG. 9 illustrates an exemplary embodiment of a modular fabrication platform having six cleaning/drying modules.

FIG. 10 illustrates an exemplary embodiment of an integrated thermo/plasma fabrication system with four cleaning/drying modules.

### DESCRIPTION

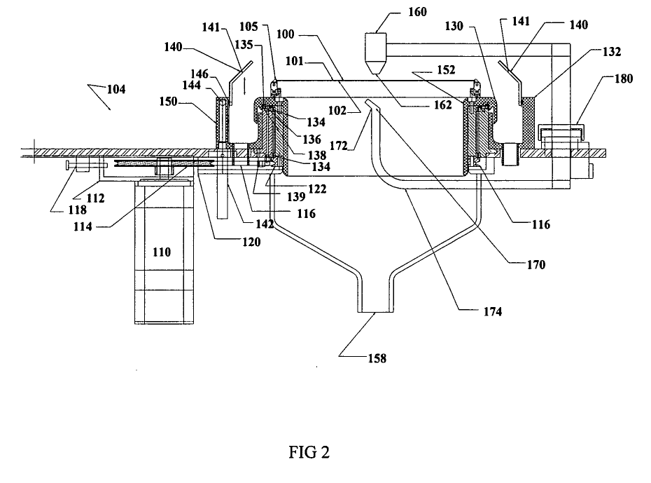

FIG. 2 shows an apparatus to process a wafer 100 having first and second sides (such as the front and back of the wafer, for example) 101-102, respectively. The wafer is mounted on a platform 104 adapted to securely receive and rotate the wafer. The apparatus has a hollow center to allow first and second process heads 160 and 170 mounted on the platform 104 to access the first and second sides 101-102 of the wafer 100. In one embodiment, the first head 160 is positioned above the top side of the wafer 100 and the second head 170 is positioned below the bottom side of the wafer 100. A wafer substrate holder is located on top of an inner housing 130 to hold the substrate or wafer 100 in proper position while the wafer 100 is rotating.

The heads 160 and 170 include nozzles 162 and 172, respectively, at one end of each of heads 160 and 170 for ejecting/spraying streams of processing materials onto the surfaces of the wafer 100. The head can be a sonic device such as a Megasonic nozzle, high pressure nozzle, brush and among others. The arrangement of the apparatus of FIG. 2 allow nozzles 162, 172 and process heads 160,170 to reach the wafer 100 from both sides 101-102 without restriction. The heads 160 and 170 can be mounted on a radial arm as shown or alternatively can be actuated by a linear motor.

During operation, the wafer 100 is securely held in place by a wafer retainer 105 and rotated by a drive assembly including a motor 110 which is mounted by a bracket 112 to the platform. The motor 110 rotates a pulley 114, which drives a belt 116. A tensioning bolt 118 allows for adjusting the position of the pulley 114 to tighten or slacken the tension on the belt 116. A cover 120 houses the pulley 114 and belt 116 to protect these elements from the environment.

The drive assembly includes two bearings 134 for the rotating assembly. The bottom of the inner ring housing mounted to a second pulley 122 which is driven by the belt 116. Non-metallic material inner and outer housings 130 and 132 are mounted to the drive assembly to provide mounting hardware and to prevent moisture and liquid from getting into rotating bearing assembly 134.

The outer housing 132 has a tub or shroud 140 to collect liquid and drain hole to vent air and liquid to a drainpipe. The outer housing 132 also has a shroud 140 that can be moved up and down: the shroud 140 is in a lower position during wafer loading and un-loading, and is at an upper position during wafer rotation process sequences.

The assembly with magnets 144-146 located inside the outer housing 132 moves the shroud 140 up and down. A labyrinth seal between inner and outer tub applied to prevent liquid getting into bearing. Additional protection, a felt ring seal 135 is located between outer bearing drive housing to prevent moisture from getting into the bearing 134. From the outer bearing assembly, positive pressure airline 139 also supplies dry air to the bearing assembly. The foregoing protection prevents moisture from getting into the bearing assembly: there is no metallic material, hardware and mechanism that is exposed liquid. Hence, the arrangement advantageously prevents any corrosion and contamination to the substrate or wafer 100. Although a belt-drive system has been described, the drive system can also be a direct drive motor system.

The shroud 140 has a mesh 141 that contains sprayed materials within the apparatus and to avoid liquid from flashing back toward the wafer during high speed spinning. Water is injected behind the fine mesh 141, and the spacing between the shroud 140 and the mesh 141 can be between 0.125″ and 1.0″, preferably 0.25″. The movement of the shroud 140 is actuated by one or more actuators 142. In one embodiment, the actuator is an air cylinder. The moving end of the actuator 142 is provided with a magnet 144 that magnetically attaches to a corresponding magnet 146 mounted on the shroud 140. In this way, as the actuator 142 moves, the shroud 140 moves. The shroud is at a first position (down position) during wafer loading or unloading and the shroud is at a second position (up position) during wafer rotation or processing.

A first tub or bowl 150 collects materials streamed from the first head 160 during the processing of the wafer 100, and a second tub or bowl 152 collects material from the second head 170. Drains 154-156 are provided at the bottom of the first tub or bowl 150 to provide liquid and air exhaust for the first tub 150. Similarly, a drain 158 is provided at the bottom of the second tub 152 to remove materials from the second tub 152.

The heads 160 and 170 can move radially over the wafer 100. In the moving embodiment, a gear head motor or actuator 180 is mounted on the platform 104 to move at least one of heads 160 and 170. In one embodiment, both heads 160 and 170 are moved together. The actuator 10 can be motor. The heads 160 and 170 are connected by arms 164 and 174 to the head actuator 180. More than one head/arm can be used with the platform as required.

Turning now to the heads 160 and 170, each head 160 or 170 includes one or more nozzles 162 or 172. At least one of the nozzles 162 or 172 expels air, gas, or a mixture thereof. Alternatively, at least one of the nozzles expels a liquid material such as DI water or a chemical material/substance. The nozzles can also emit materials at an ultrasonic or Megasonic energy or frequency. The head 160 can be a wafer cleaning device such as PVA brush with close loop control for speed and down force.

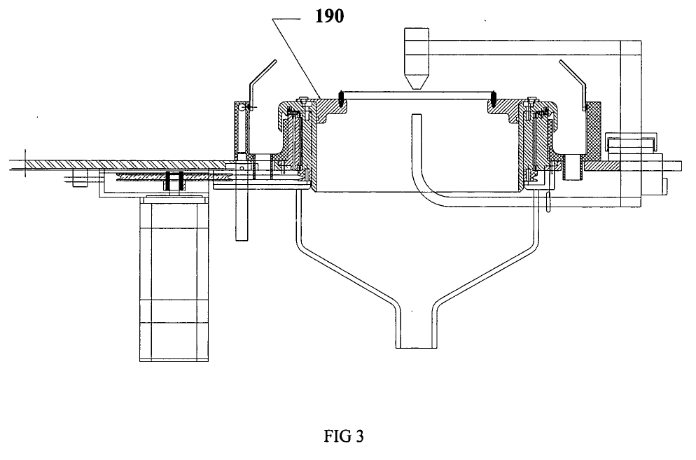

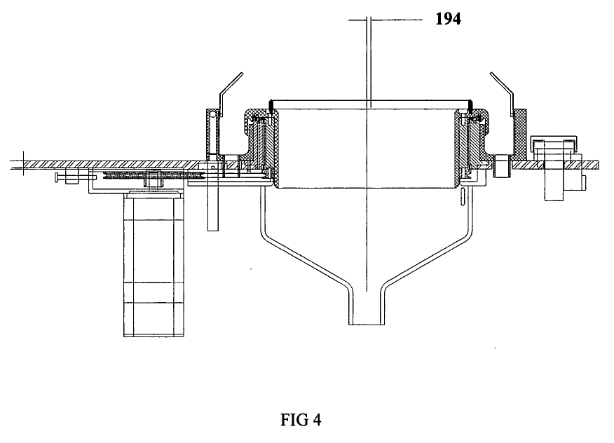

In the embodiment of FIG. 2, the wafer is a 300 millimeter wafer that seats above the inner housing 130. An adapter ring can be added to accommodate smaller wafers such as 200 mm wafers. FIG. 3 shows an embodiment that process 200 millimeter wafers. This is done by placing an adapter ring 190 in the assembly to securely receive the 200 mm wafer. In yet another embodiment shown in FIG. 4, the wafer 100 is placed at an offset 194 from a spindle center.

The systems for cleaning of semiconductor wafers can be used in conjunction with processes such as post-CMP clean, Dry/wet Post-Etch Residue cleans (Polymer Removal), Photoresist Removal and surface preparation (FEOL & BEOL), Pre-Photo Lithography, Pre-Deposition clean and dry, Back Side Metals Clean, Back Side Films Etch (Front side and/or backside), Pre-Epi Clean, among others.

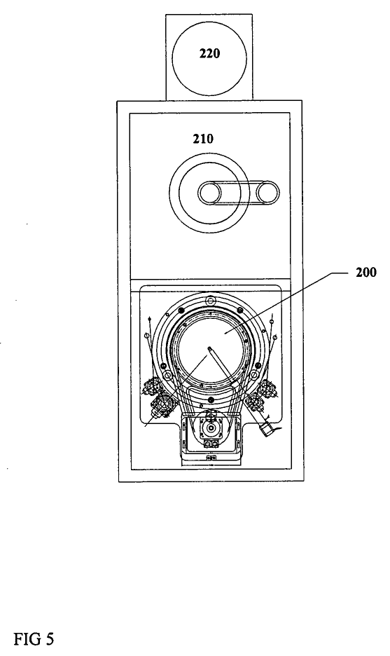

The spinning apparatus of FIGS. 2-4 can be used as stand-alone module, modulated platform systems or integrated with other processing systems. FIG. 5 illustrates an exemplary embodiment of a modular fabrication platform having one cleaning/drying cell.

In this embodiment, a processing module 200 such as the spin apparatus of FIGS. 2-4 is used in conjunction with a robot 210 and a front opening unified pod (FOUP) 220. The FOUP 220's interior is maintained at a high level of cleanliness and enables conveyance of wafers via a room of low cleanliness or the outdoors. Hence, the FOUP 220 protects wafers from contamination with dust during conveyance. In one embodiment, a FOUP opener is disposed at the interface between the interior and exterior of a clean room. The FOUP opener includes a port plate having an opening portion, which can be opened or closed, and a port door for opening/closing the opening portion. The FOUP 220 has a door which faces the opening portion of the port plate. When wafers are to be unloaded from a space maintained at a high level of cleanliness (a first control space) within the FOUP in order to undergo processing steps, the FOUP door is opened. Unloaded wafers are robotically conveyed by the robot 210 within a wafer transfer space maintained at a high level of cleanliness similar to that in a processing chamber, and then transferred into the processing module 200. Processed wafers are returned from the processing module 200 to the space within the FOUP 220 by the robot 210. Thus, wafers are moved through the opening portion of the port plate. When no wafer is moved, the opening portion of the port plate is closed by means of the port door.

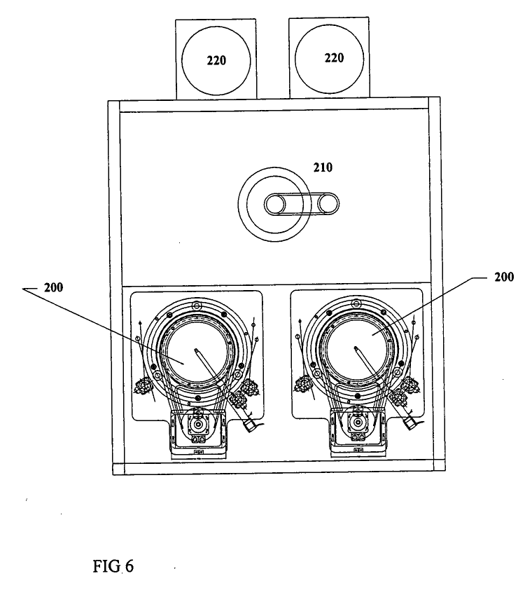

FIG. 6 illustrates an exemplary embodiment of a modular fabrication platform having two processing modules 200 which can be cleaning/drying cells. A robot 212 conveys wafers between the processing modules and one or more FOUPs 220.

In one embodiment, the robot includes a loading/unloading mechanism moving in a direction (Y direction) in which the robots for loading and unloading wafers into and out of the FOUPs 220 and the processing modules 200. The loading/unloading mechanism includes a loading/unloading arm not shown, and is capable of rotating about a vertical axis, moving up and down in the vertical direction, and moving the loading/unloading arm back and forth in addition to moving horizontally. Thus, the loading/unloading mechanism loads and unloads the wafers into and out of the FOUPs 220, and transfers and receives the wafers to and from the processing modules 200.

The processing modules 200 are spaced in one line arranged in the Y direction, each of the lines being formed by two modules 200 arranged in a direction (X direction) perpendicular to the Y direction.

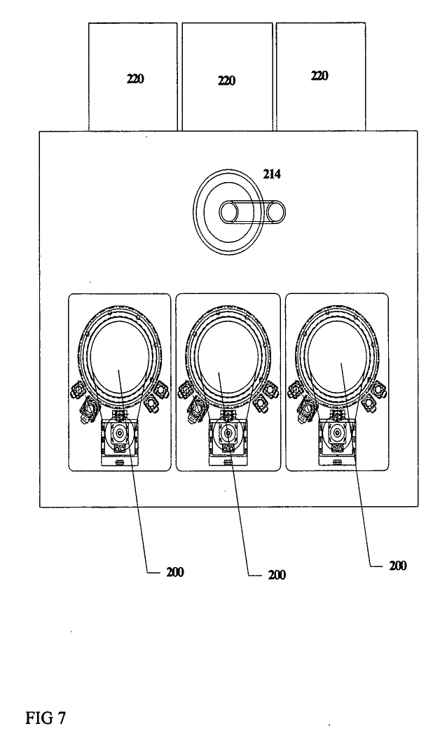

FIG. 7 illustrates an exemplary embodiment of a modular fabrication platform having three cleaning/drying modules 200, a robot 214 and three FOUPs 220. The arrangement of the system of FIG. 7 is similar to that of FIG. 6, with the addition of another set of processing module 200 and FOUP 220.

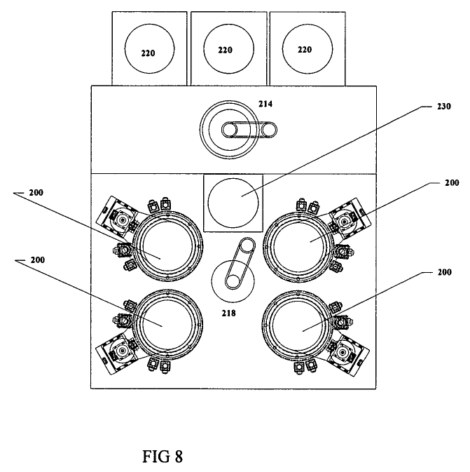

FIG. 8 illustrates an exemplary embodiment of a modular fabrication platform having four processing modules 200 which can be cleaning/drying cells discussed above. The system of FIG. 8 has three FOUPs 220 and a robot 214. Four processing modules 200 are arranged in a circular layout where the modules 200 are equidistant to a second robot 218. The second robot 218 can transfer wafers between the modules 200 and the robot 214 through the wafer storage 230 for subsequent transfer to one of the FOUPs 220.

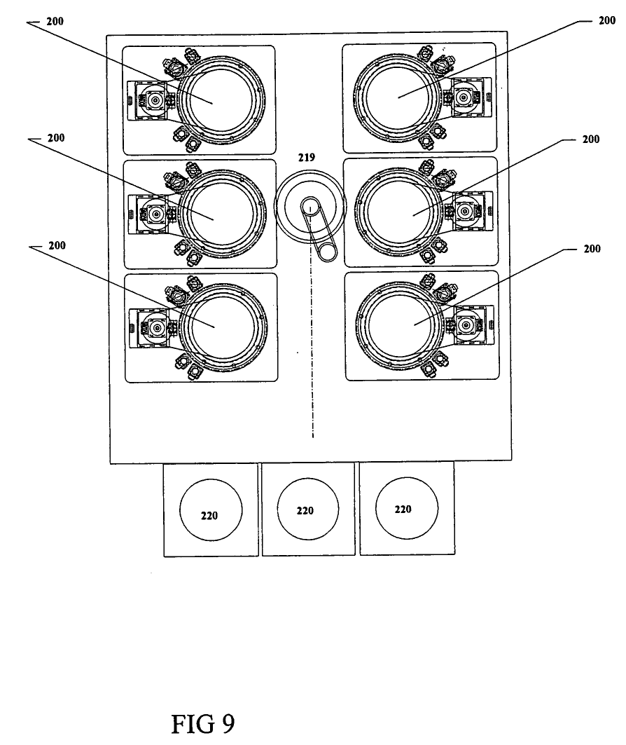

FIG. 9 illustrates an exemplary embodiment of a modular fabrication platform having six processing modules 200, which can be cleaning/drying cells. In this embodiment, the robot includes a loading/unloading mechanism moving in both X and Y directions in which the robot 219 for loading and unloading wafers into and out of the three FOUPs 220 and the six processing modules 200. The loading/unloading mechanism includes a loading/unloading arm not shown, and is capable of rotating about a vertical axis, moving up and down in the vertical direction, and moving the loading/unloading arm back and forth in addition to moving horizontally. Thus, the loading/unloading mechanism loads and unloads the wafers into and out of the FOUPs 220, and transfers and receives the wafers to and from the processing modules 200. The processing modules 200 are spaced in two lines arranged in the X direction, each of the lines being formed by a module 200 arranged in a Y direction perpendicular to the X direction.

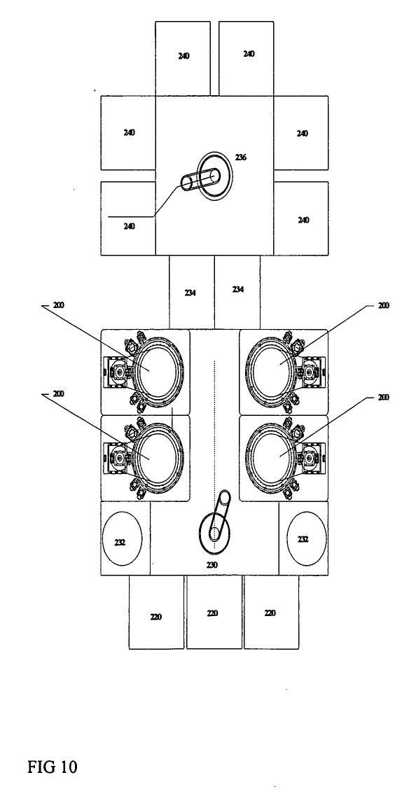

FIG. 10 illustrates an exemplary embodiment of an integrated thermo/plasma fabrication system with four cleaning/drying cells. The integrated chamber does not required wet wafer transfer from module to module, thus improving throughput and reducing wafer contamination and defects.

In the system of FIG. 10, a plurality of FOUPs 220 receives wafers as described above. A robot 230 moves the wafers to and from the processing modules 200 for cleaning or drying. One or more inline-metrology devices 232 are provided to perform wafer measurements. In one embodiment, the metrology devices 232 operate by directing light at the surface to be measured and measure the characteristics (e.g., intensity, angle of reflection, diffraction, scattering, etc.) of the light reflected from the surface. The characteristics are then used to calculate various properties of the thin film covering the wafer surface, such as, the index of refraction, extinction coefficient, and thickness of the thin film. Exemplary of existing metrology units include the Nanospec 9000.™. manufactured by Nanometrics.™., the Thermawave 3260 manufactured by ThermaWave, and the UV1050 manufactured by KLA-Tencor. By having the metrology devices nearby, the transport steps to the metrology devices lowers the overall throughput of wafers.

Upon completion of cleaning/drying/metrology operations, the robot 230 moves the wafers to a storage chamber 234. A second robot 236 transfers the wafers to one or more process chambers 240 for subsequent processing. Generally, a set of processing steps is performed on a lot of semiconductor wafers. For example, a process layer composed of a variety of materials may be formed above a wafer. Thereafter, a patterned layer of photoresist may be formed above the process layer using known photolithography techniques. Typically, an etch process is then performed on the process layer using the patterned layer of photoresist as a mask. This etching process results in formation of various features or objects in the process layer. Such features may be used for a gate electrode structure for transistors. Many times, trench structures are also formed on the substrate of the semiconductor wafer. One example of a trench structure is a shallow trench isolation (STI) structure, which can be used to isolate electrical areas on a semiconductor wafer. Typically, STI structures formed on the semiconductor wafers are filled by forming silicon dioxide using tetraethoxysilane (TEOS), over the wafer and in the STI structures. Each manufacturing tool is generally connected to an equipment interface. The equipment interface is connected to a machine interface to which a manufacturing network is connected, thereby facilitating communications between the manufacturing tool and the manufacturing framework. The machine interface can generally be part of an advanced process control (APC) system. The APC system initiates a control script, which can be a software program that automatically retrieves the data needed to execute a manufacturing process.

Although the invention has been described with reference to particular embodiments, the description is only an example of the inventor's application and should not be taken as limiting. Various adaptations and combinations of features of the embodiments disclosed are within the scope of the invention as defined by the following claims.

1. An apparatus to process a wafer having first and second sides, comprising:
a platform adapted to receive and rotate said wafer; and
first and second heads coupled to the platform to access said first and second sides of said wafer.

2. The apparatus of claim 1, comprising a drive assembly coupled to said platform.

3. The apparatus of claim 2, wherein said drive assembly comprises a direct drive motor.

4. The apparatus of claim 2, wherein said drive assembly comprises a motor coupled to a pulley and a belt.

5. The apparatus of claim 4, comprising a second pulley rotated by said belt and coupled to one or more bearings to rotate said wafer.

6. The apparatus of claim 5, comprising a positive pressure air region surrounding said one or more bearings.

7. The apparatus of claim 2, wherein said drive assembly is moisture-proof.

8. The apparatus of claim 1, comprising a first bowl adapted to collect material from said front side of a wafer.

9. The apparatus of claim 1, comprising a second bowl adapted to collect material from said back side of a wafer.

10. The apparatus of claim 8 or 9, comprising a drain at one end of each bowl.

11. The apparatus of claim 1, comprising a shroud and a mesh to prevent liquid from flashing the wafer.

12. The apparatus of claim 11, wherein said shroud is moveable.

13. The apparatus of claim 11, comprising:
a first magnet coupled to said shroud; and
an actuator having moveable end having a second magnet coupled thereto, said first and second magnets securing said shroud to said actuator.

14. The apparatus of claim 11, wherein said shroud is at a first position during loading or unloading and wherein said shroud is at a second position during wafer rotation.

15. The apparatus of claim 1, comprising a head actuator coupled to said platform to move at least one head.

16. The apparatus of claim 1, wherein each head comprises one or more process devices.

17. The apparatus of claim 17, wherein at least one of said the head has a nozzle that expels air, gas, supercritical CO₂ or a mixture thereof.

18. The apparatus of claim 1, wherein at least one of said the head has a nozzle that expels a liquid material or N2 mixture.

19. The apparatus of claim 1, wherein at least one of said the head has a nozzle that expels a chemical material or mixture.

20. The apparatus of claim 1, wherein at least one of said the head has a nozzle that emits sonic energy including one of: ultrasonic energy and Megasonic energy.

21. The apparatus of claim 1, wherein at least one of said the head has a rotating device with a close loop control for rotation speed and down force.

22. The apparatus of claim 1, wherein said wafer comprises a 300 millimeter wafer.

23. The apparatus of claim 1, wherein said wafer comprises a 200 millimeter wafer, comprising an adapter ring coupled to said platform to process said wafer.

24. The apparatus of claim 1, wherein said wafer is offset from a spindle center.
